(19) United States
(12) Patent Application Publication
(10) Pub. No.: US 2008/0056111 A1
(43) Pub. Date: Mar. 6, 2008

(54) Optical Data Storage Medium and Manufacturing Methods Therefor

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,625

(22) PCT Filed: Jun. 23, 2005
(86) PCT No.: PCT/IB05/52065

§ 371 Date: Dec. 14, 2006

(30) Foreign Application Priority Data
Jun. 28, 2004 (EP) 04102998.4

(51) Int. Cl. G11B 7/24

(52) U.S. Cl. 369/275.4

(57) ABSTRACT

An optical data storage medium is described. It comprises at least a substrate, having a surface with data stored in pits that are embossed into the substrate and in spaces separating the pits, a reflective layer covering the surface and having an intrinsic optical reflectivity R at a wavelength λ, a transparent cover stack formed on the reflective layer, the pattern of pits being readable through the cover stack by means of the focused radiation beam having the wavelength λ. The value of R on the spaces separating the pits is substantially different from the value of R on the bottom of the pits. An improved signal quality is achieved, e.g for BD-ROM discs. Further methods for manufacturing such a medium are described, e.g. inclined sputtering or selective etching.

The invention relates to an optical data storage medium comprising at least:
a substrate, having a surface with data stored in pits that are embossed into the substrate and in spaces separating the pits,
a reflective layer covering the surface and having an intrinsic optical reflectivity R at a wavelength λ,
a transparent cover stack formed on the reflective layer, the pattern of pits being readable through the cover stack by means of the focused radiation beam having the wavelength λ.

The invention further relates to methods of manufacturing such a medium.

Readout of read only (ROM) optical media is based on phase-modulation of a focused radiation beam, e.g. a laser beam, when reflected on a pit pattern. In digital versatile disc (DVD) and compact disc (CD) type of media, the pits were replicated in the substrate and subsequently covered by a thin metallic layer. This reflective layer resulted in a high reflection signal. Since the readout of data is achieved via the substrate side of the disc, the pit shape is well preserved. In the newer high density Blu-Ray Disc (BD) ROM, the ROM information is also replicated in a substrate, the pit pattern is subsequently covered with a metallic mirror. The next generation discs like BD differs from the older discs like CD and DVD in that the data are read from the opposite side of the disc, namely through a thin cover cover layer. This results in a somewhat deteriorated pit shape due to the non-perfect transfer by the metallic layer of the pit shape. The difference between readout through the substrate and readout through the cover in case the pits are replicated in the substrate is illustrated in FIG. 1. In particular in case of small channel bit lengths (CBL), such as in 27 GB BD discs, the non-perfect pit shape may lead to increased timing jitter. Also the process window for the 25 GB and 23.3 GB versions of the BD disks may suffer from the non perfect transfer of the pit shape through the metallic readout layer. Three data capacities are prescribed in the BD-ROM standard, namely 23.3, 25 and 27 GB recorded on a single 12 cm rewritable disc. The smallest pit lengths corresponding to e.g. the 27, 25 and 23.3 GB density are 160, 149 and 138 nm (corresponding to 2 channel bit lengths also called 12) respectively.

It is an object of the invention to provide an optical data storage medium of the kind described in the opening paragraph with improved signal read-out quality, in partical reduced timing jitter.

It is a further object to provide a method for manufacturing such an optical data storage medium.

According to the invention this object is achieved with the optical data storage medium as claimed in claim 1, which is characterized in that the value of R on the spaces separating the pits is substantially different from the value of R on the bottom of the pits. It should be noted that the definition of the reflection value R is such that it is based on material properties of the reflective layer and not on optical interference effects due to e.g. phase difference of the radiation reflected from the bottom of a pit and the land. A good solution would be an ultra-thin homogeneous layer with high reflection value R. However such a layer is hardly realizable. It is therefore proposed in an embodiment according to the invention to apply a patterned reflective layer that is only or predominantly present on the spaces separating the pits, also called lands, of the replicated area. In another embodiment the reflective layer is only or predominantly present on the bottom of the pits.

Preferably the reflective layer comprises a material having a refractive index nᵣ substantially different from a refractive index n_{c} of the material of the cover stack in order to achieve sufficient reflection at the interface between the reflective layer and the cover stack.

In an embodiment the reflective layer is a metallic layer, e.g. Ag or Al or other suitable metals and alloys thereof.

Since only the spaces separating the pits or the bottom of the pits are covered with a reflective layer, amplitude modulation will also be a dominant contribution to pit detection. The non-replicated part of the disc is covered with the reflective layer, while the embossed replicated pits are seen as holes in this layer or the bottom of the pits are small mirrors enhancing the signal and hence improving the signal quality.

In an embodiment λ is about 405 nm, the pits are formed in a spiral shape track pattern, having a trackpitch of 0.320+/−0.010 μm, and the length of the pits in the track direction is modulated according to a run length limited code with runlengths≧2CBL and ≦8CBL where CBL=80.00 nm+/−0.07 nm, 74.50 nm+/−0.07 nm or 69.00 nm+/−0.07 nm. These parametric values correspond to the BD ROM format.

According to the invention the further object is achieved with the method as claimed in claim 8 comprising the steps of:
providing a substrate, having a surface with data stored in pits that are embossed into the substrate and in spaces separating the pits,
providing a reflective layer covering the surface by inclined sputter deposition, with an inclination angle such that the reflective layer predominantly is deposited on the land area surface of the substrate,
providing a transparent cover stack formed on the reflective layer.

Such a patterned reflective layer can, for example, be obtained by inclined sputter deposition. Use is made of the so-called shadow effect. If the inclination angle of incident is larger than about 45° (with respect to normal incidence which is taken as 0°), the bottom of the shortest pit, e.g. an I2 pit, will not be covered by the bombarding atoms. As a consequence, only the adjacent lands are covered with a reflective layer. The bottom of longer pits, such as 8 run lengths, i.e. I8, may be covered by a thin reflective layer, but this can be done uniformly by rotation of the disc during sputtering. The thin reflective layer at the bottom has a much lower intrinsic reflection value than the reflective layer on the land area.

Alternatively, the further object is achieved with the method as claimed in claim 9 comprising the steps of

a) providing a substrate, having a surface with data stored in pits that are embossed into the substrate and in spaces separating the pits,

b) providing a layer covering the surface by spincoating such that said layer has a larger thickness in the pits than at the spaces,

c) isotropically etching the spincoated layer such that only the bottom part of the pit is covered with the spin-coated layer,

d) providing a transparent cover stack formed on the substrate and the spincoated layer.

In an embodiment the spincoated layer comprises a material having a refractive index nᵣ substantially different from a refractive index n_{c} of the material of the cover stack in order to achieve sufficient reflection at the interface between the reflective layer and the cover stack.

Another embodiment of the method comprises the following steps between step c) and step d) of the method:

c′) depositing a further reflective layer on the spaces separating the pits, on the spincoated layer covering the bottom part of the pits and on the side walls of the pits,

c″) removing the spincoated layer covering the bottom part of the pits, including the portion of the further reflective layer covering this spincoated layer. In this way it is prevented that material of the further reflective layer is deposited at the bottom of the pits.

Alternatively a patterned reflective layer may be provided by printing techniques such as e.g. off-set printing or dip-coating.

The optical data storage medium and the method of manufacturing will be elucidated in greater detail with reference to the accompanying drawings, in which

FIG. 1 shows a schematic cross section of an optical data storage medium according to prior art to illustrate the difference between readout through the substrate and readout through the cover in case the pits are replicated in the substrate.

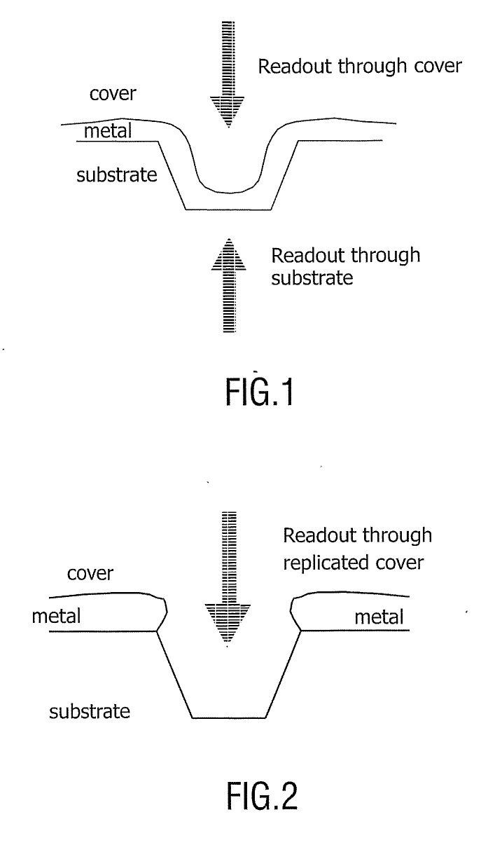

FIG. 2 shows a schematic cross section of an optical data storage medium according to the invention with patterned reflective layer to improve the readout of a BD-ROM disc.

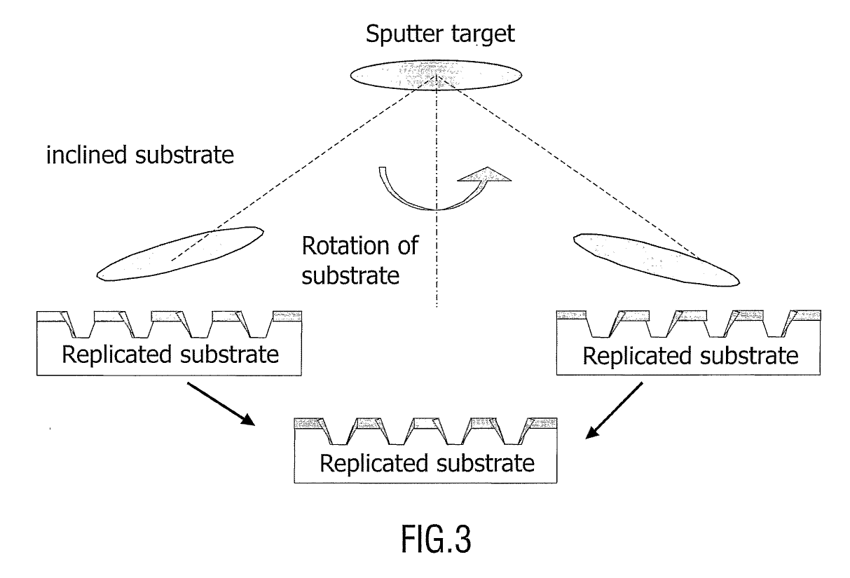

FIG. 3 shows a setup for performing the step of depositing a reflective layer covering the surface by inclined sputter deposition of the manufacturing method according to the invention.

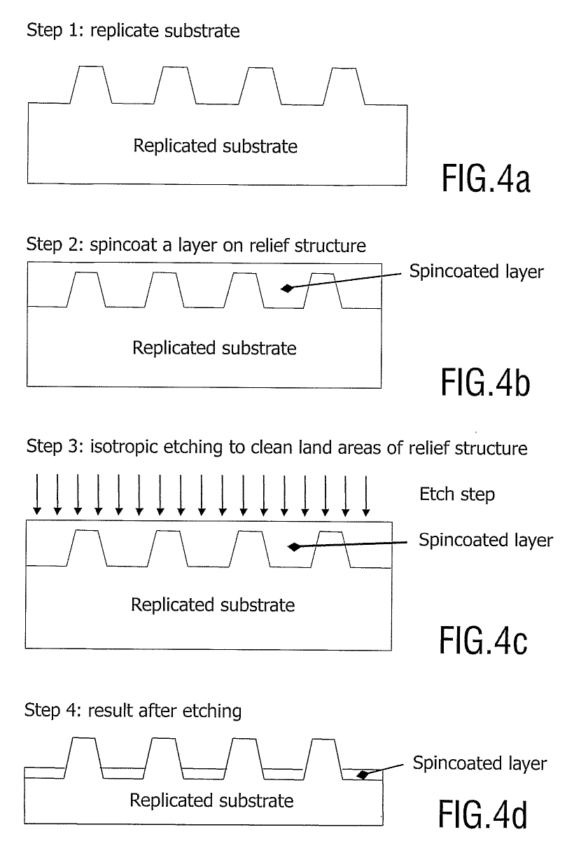

FIG. 4 shows the steps of the manufacturing method according to the invention for achieving a reflective layer covering the bottom of pits.

In FIG. 1 a schematic cross section of an optical data storage is shown illustrating the difference between readout through the substrate and readout through the cover for the case the pits are replicated in the substrate. The metal layer acts as a reflective layer. The shape of the surface between the reflective layer and the cover layer has a somewhat deteriorated pit shape compared to the surface between the reflective layer and the substrate. This is due to the non-perfect transfer by the reflective layer of the pit shape. In particular in case of small pits representing small channel bit lengths (CBL), such as in 27 GB BD discs, the non-perfect pit shape may lead to increased timing jitter.

In FIG. 2 a schematic cross section an optical data storage medium according to the invention is shown. It comprises a substrate, which has a surface with data stored in pits that are embossed into the substrate and in spaces separating the pits. A reflective layer covers the surface and has an intrinsic optical reflectivity R for a focused radiation beam, e.g. the laser beam of an optical pick up unit of an optical data storage medium reading device. A transparent cover stack is formed on the reflective layer. The pattern of pits is readable through the cover stack by means of the focused radiation beam. The value of R on the spaces separating the pits is substantially higher than the value of R on the bottom of the pits. This is because the reflective layer predominantly is present on the spaces separating the pits. The reflective layer comprises a material having a refractive index nᵣ substantially different from a refractive index n, of the material of the cover stack in order to achieve sufficient reflection at the interface between the reflective layer and the cover stack. E.g. the reflective layer is a 15 nm layer made of Al having a refractive index nᵣ=0.7−4.6i at 405 nm wavelength and the cover layer is made of, for example, a UV cured transparent material or polycarbonate film with a refractive index n_{c}=1.5 . . .

According to the BD ROM standard the pits are formed in a spiral shape track pattern, having a trackpitch of 0.320+/−0.010 μm. The length of the pits in the track direction is modulated according to a run length limited code with runlengths≧2CBL and ≦8CBL where CBL=80.00 nm+/−0.07 nm or 74.50 nm+/−0.07 nm.

In FIG. 3 a setup for performing the step of depositing a patterned reflective layer covering the surface by inclined sputter deposition or shadow sputtering of the manufacturing method according to the invention is shown. The substrate is placed at an inclination angle with respect to the sputter target. The optimum inclination angle is directly related to the depth of the pit structure in the substrate to be covered with a patterned reflection layer. In most cases, an angle between 20 and 80° is preferred. The inclination is chosen such that the reflective layer predominantly is deposited on the spaces between the pits, i.e. the land area surface, of the substrate. At one position of the inclined substrate with respect to the sputter target, the deposited reflection layer becomes asymmetric because of the shadow effect. This is illustrated in the left image in FIG. 3. If the substrate is placed at the opposite side of the target at the same inclination angle, s similar asymmetric patterned reflection layer is obtained, but in this case with the opposite layer coverage. To obtain a symmetric coverage of the substrate, rotation of the substrate with respect to the sputter target is proposed. This results in the a symmetric patterned layer as illustrated in the lower panel in FIG. 3.

In FIG. 4 a second method to obtain a patterned reflection layer is illustrated. The replicated substrate (FIG. 4a) is provided with a layer via spincoating. This layer needs to have a substantial index of refraction mismatch with respect to the cover layer that is provided on top of the disc for readout. The spincoated layer is subsequently isotropically etched such that only the bottom part of the pit is covered with the spin-coated layer. In this way, a patterned reflection layer results (see FIG. 4d). Suitable materials that have a substantially different index of refraction than the cover layer are, for example, phtahalocyanine dyes, cyanaine dyes, Azo dyes. Also Diazonaphthoquinone-based resists can be etched in a controlled manner with NaOH or KOH developer liquids. An isotropic UV illumination step may be applied to speed up the etching of the photo-resist layer. Alternatively (not shown) it is possible to deposite a further reflective layer on the spaces separating the pits, on the spincoated layer covering the bottom part of the pits and on the side walls of the pits, and subsequently to remove the spincoated layer covering the bottom part of the pits, including the portion of the further reflective layer covering this spincoated layer. The further reflective layer may be deposited by normal sputtering methods or by the method of inclined sputter deposition as described with FIG. 3.

1. An optical data storage medium comprising at least:
a substrate, having a surface with data stored in pits that are embossed into the substrate and in spaces separating the pits,
a reflective layer covering the surface and having an intrinsic optical reflectivity R at a wavelength λ,
a transparent cover stack formed on the reflective layer, the pattern of pits being readable through the cover stack by means of the focused radiation beam having the wavelength λ, characterized in that the value of R on the spaces separating the pits is substantially different from the value of R on the bottom of the pits.

2. A medium as claimed in claim 1, wherein the reflective layer is only or predominantly present on the spaces separating the pits.

3. A medium as claimed in claim 1, wherein the reflective layer is only or predominantly present on the bottom of the pits.

4. A medium as claimed in claim 2, wherein the reflective layer comprises a material having a refractive index nᵣ substantially different from a refractive index n_{c} of the material of the cover stack in order to achieve sufficient reflection at the interface between the reflective layer and the cover stack.

5. A medium as claimed in claim 4, wherein the reflective layer is a metallic layer.

6. A medium as claimed in claim 5, wherein λ is about 405 nm and the pits are formed in a spiral shape track pattern, having a trackpitch of 0.320+/−0.010 μm.

7. A medium as claimed in claim 6, wherein the length of the pits in the track direction is modulated according to a run length limited code with runlengths≧2CBL and ≦8CBL where CBL=80.00 nm+/−0.07 nm or 74.50 nm+/−0.07 nm.

8. A method of manufacturing a medium as claimed in claim 1, comprising the steps of
providing a substrate, having a surface with data stored in pits that are embossed into the substrate and in spaces separating the pits,
providing a metallic reflective layer covering the surface by inclined sputter deposition, with an inclination angle such that the reflective layer predominantly is deposited on the land area surface of the substrate,
providing a transparent cover stack formed on the reflective layer.

9. A method of manufacturing a medium as claimed in claim 1, comprising the steps of
a) providing a substrate, having a surface with data stored in pits that are embossed into the substrate and in spaces separating the pits,
b) providing a layer covering the surface by spincoating such that said layer has a larger thickness in the pits than at the spaces,
c) isotropically etching the spincoated layer such that only the bottom part of the pit is covered with the spin-coated layer,
d) providing a transparent cover stack formed on the substrate and the spincoated layer.

10. A method of manufacturing a medium as claimed in claim 9, wherein the spincoated layer comprises a material having a refractive index nᵣ substantially different from a refractive index n_{c} of the material of the cover stack in order to achieve sufficient reflection at the interface between the reflective layer and the cover stack.

11. A method of manufacturing a medium as claimed in claim 9, additionally comprising the following steps between step c) and step d):
c′) depositing a further reflective layer on the spaces separating the pits, on the spincoated layer covering the bottom part of the pits and on the side walls of the pits,
c″) removing the spincoated layer covering the bottom part of the pits, including the portion of the further reflective layer covering this spincoated layer.
